(19) United States
(12) Patent Application Publication
(10) Pub. No.: US 2007/0154589 A1
(43) Pub. Date: Jul. 5, 2007

(54) Injection core assembly for injection molding machine tooling

(76) Inventor: Randal L. Fields, Greenwood, MO (US)

Correspondence Address: HOVEY WILLIAMS LLP, 2405 GRAND BLVD., SUITE 400, KANSAS CITY, MO, 64108, US

(21) Appl. No.: 11/324,363

(22) Filed: Jan. 3, 2006

(51) Int. Cl. B29C 33/76

(52) U.S. Cl. 425/577

(57) ABSTRACT

A two-piece core assembly comprising part of the tooling used in an injection molding machine has a core body and a core tip that is secured to one end of the body. Preferably, the tip and body are constructed from two different metallic materials. To assemble the parts, a socket at the end of the core body may be induction heated to expand the recess of the socket sufficiently to permit the normally larger base end of the tip to be inserted into the recess, followed by cooling the socket to room temperature to cause the socket to shrink and tightly grip the tip against dislodgement.

### TECHNICAL FIELD

The present invention relates to tooling for injection molding machines, and, more particularly, to an injection core assembly for use in molding preforms.

### BACKGROUND

In the molding of preforms, a mold cavity having the desired shape of the finished preform is cooperatively defined by the cavity within a hollow mold and an elongated core inserted into the cavity. The void area formed between the finished surfaces of the core and the mold becomes the mold cavity for receiving the hot, molten plastic material that will solidify into a preform.

It is standard practice in the art to make injection cores from a single metallic material. Yet, choosing the appropriate material represents a compromise at best because, on the one hand, the tip portion of the core that comes in contact with the plastic material must have highly finished molding surfaces and exhibit an appropriate level of thermal conductivity. The body portion of the core, on the other hand, need not be finished and should be as wear-resistant as possible to withstand the daily grind of machine operations. In order to achieve the desired level of thermal conductivity for some jobs, expensive and exotic metals have been used for the entire core, although this may sacrifice the wear-resistance of the core.

### BRIEF DESCRIPTION OF THE DRAWINGS

FIG. 1 is a fragmentary, partly cross sectional and partly elevational view of an injection molding machine having tooling constructed in accordance with the principles of the present invention;

FIG. 2 is an enlarged elevational view of a fully assembled two-piece injection core assembly that forms a part of the tooling of FIG. 1;

FIG. 3 is a longitudinal cross sectional view thereof taken substantially along line 3-3 of FIG. 2;

FIG. 4 is a longitudinal cross sectional view of the core body of the assembly; and

FIG. 5 is a longitudinal cross sectional view of the core tip of the assembly.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

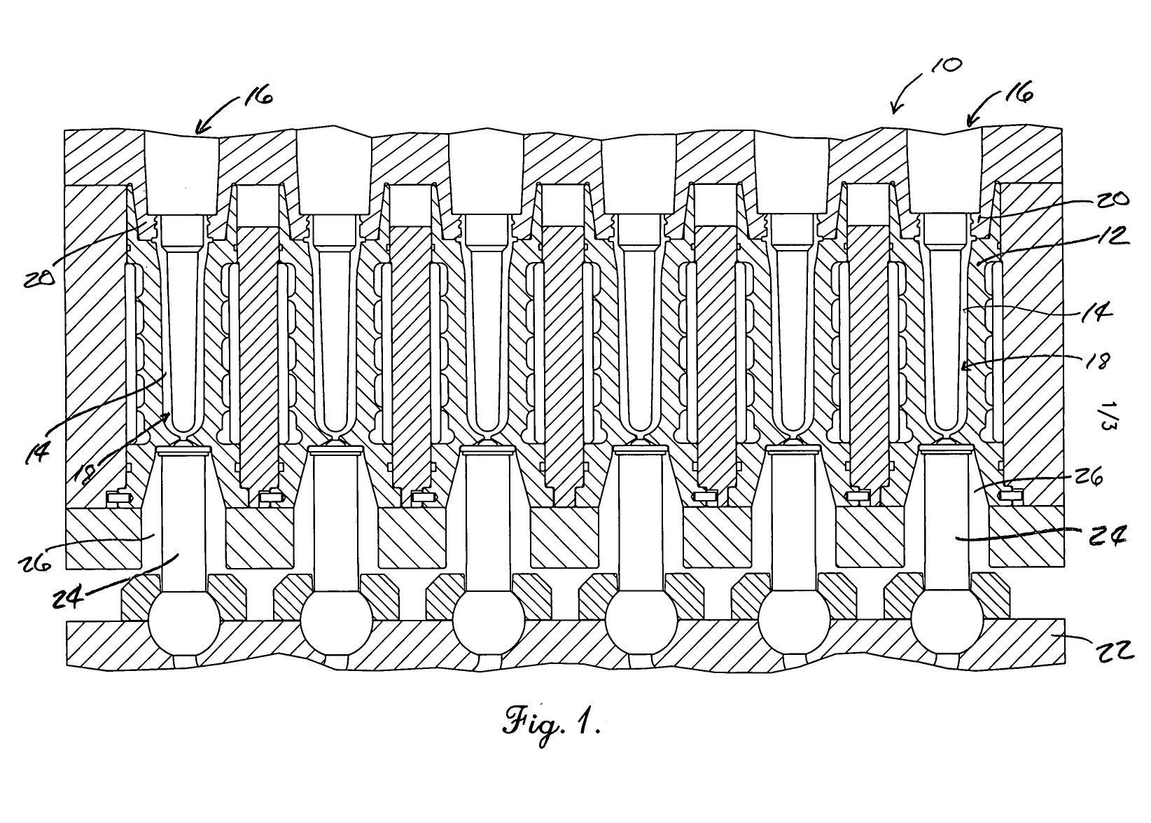

The injection molding machine of FIG. 1 has tooling 10 that includes a mold 12 having a plurality of cavities 14 defined therein. A plurality of corresponding core assemblies 16 may be moved vertically into and out of cavities 14 to cooperate with mold 12 in the formation of preform mold cavities 18. Thread splits 20 define the upper portion of each preform mold cavity 18 and serve to grip and transport the preform to the next station while it is still on core assembly 16 at the completion of each molding cycle. Tooling 10 also includes a manifold block 22 and a series of injection nozzles 24 that project upwardly from block 22 into corresponding wells 26 in the bottom of mold 12 to supply hot melt into preform mold cavities 18 during the molding cycle. The manifold block and nozzle arrangement may take the form of that disclosed in U.S. Pat. No. 6,726,467 which is assigned to the assignee of the present invention and is hereby incorporated by reference into the present specification.

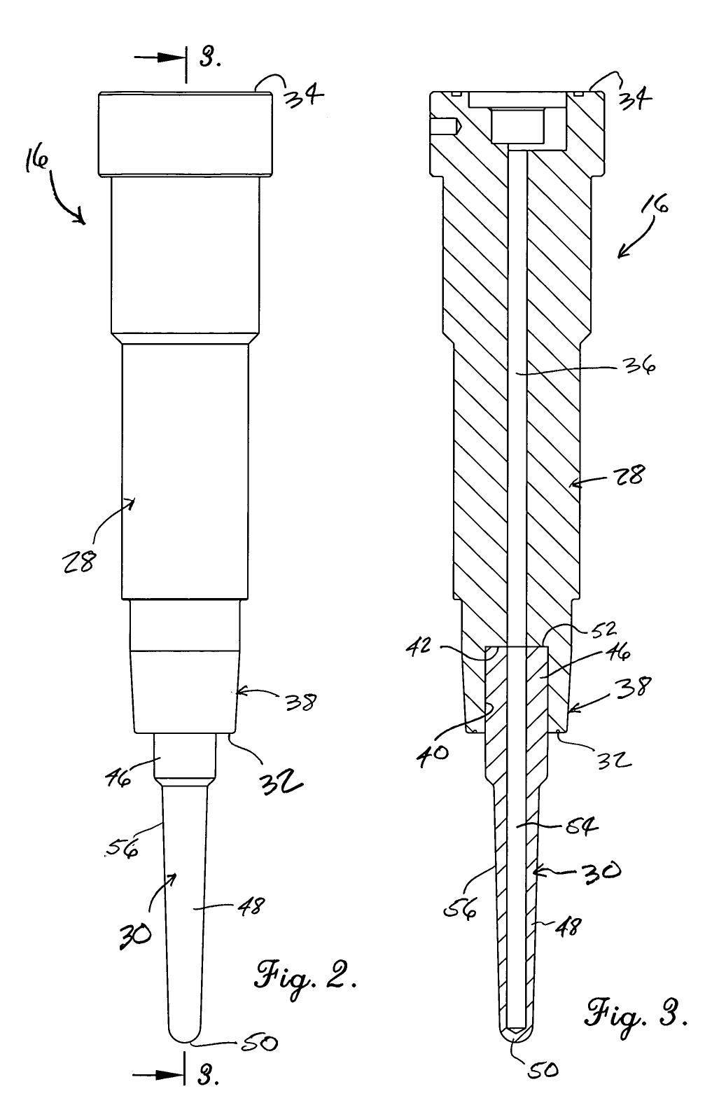

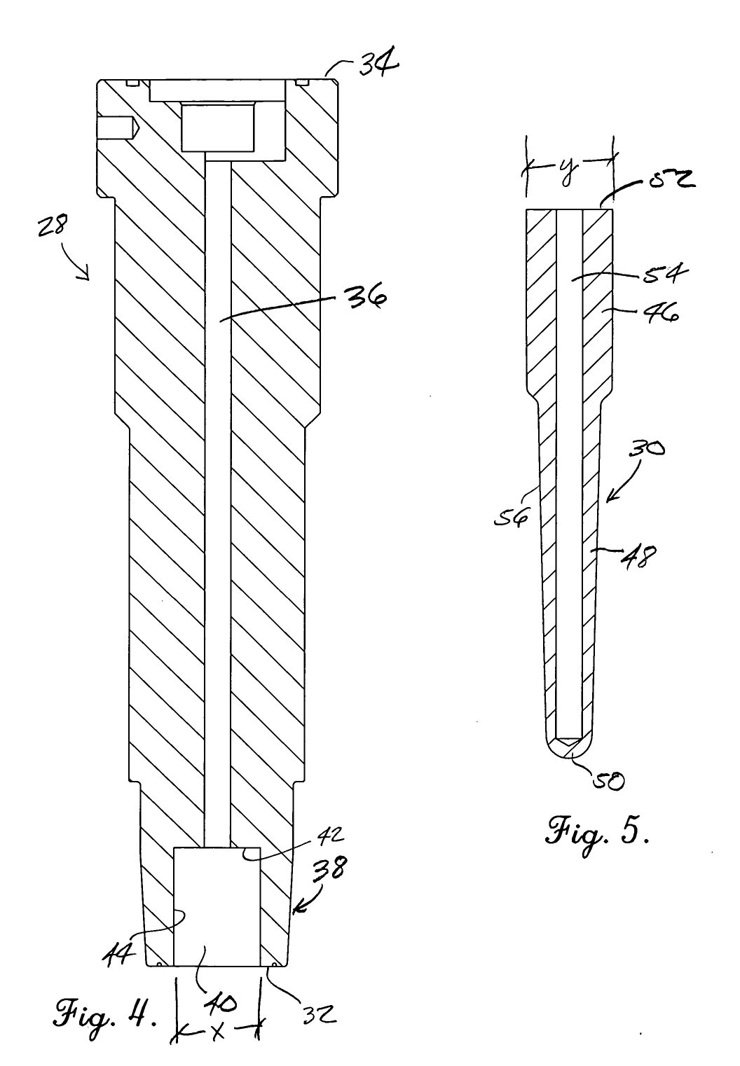

Turning particularly to FIGS. 2-5, it will be seen that each core assembly 16 is of two-part construction, comprising an elongated, generally cylindrical core body 28 and a smaller, elongated core tip 30 at the lower end 32 of core body 28. FIGS. 2 and 3 show these parts assembled together into a completed assembly 16, while FIGS. 4 and 5 show the parts individually.

Core body 28 includes an upper end 34 that is somewhat enlarged with respect lower end 32. A coolant passage 36 extends the full length of core body 28 for receiving coolant during operations from a source of supply thereof (not shown). At its lower end 32, core body 28 is provided with a socket 38 having a concentrically disposed recess 40 that extends inwardly from lower end 32 and intersects with coolant passage 36. Recess 40 is larger in diameter than coolant passage 36 so as to present a floor 42 at the intersection of recess 40 and passage 36. An annular sidewall 44 extends outwardly from floor 42 to lower end 32 of core body 28. Recess 40 has an inside diameter that is denoted by the letter X.

Core tip 30 includes a cylindrical base portion 46 and a slightly tapering shank portion 48 projecting downwardly from base portion 46. A rounded nose 50 at the lower end of shank portion 48 serves to present a closed bottom end of core tip 30. The opposite, upper end 52 of core tip 30 is flat and disposed at 90° to the longitudinal axis of core tip 30. A coolant passage 52 is concentrically disposed within core tip 30 and extends from the open upper end 52 thereof to the closed nose 50. Base portion 46 of core tip 30 has an outside diameter that is denoted by the letter Y. All of the shank portion 48 and part of the base portion 46 have exterior surfaces 54 that are highly polished to serve as molding surfaces in cooperation with the polished molding surfaces of preform mold cavities 18.

As noted in FIG. 3, core tip 30 is received within socket 38 of core body 28 when core assembly 16 is in an assembled condition. Base portion 46 of core tip 30 is received by recess 40, with top end 52 of core tip 30 abutting and bearing against floor 42 of recess 40. This places coolant passages 36 and 54 in axial alignment and communication with one another so that coolant entering the upper end of passage 36 in core body 28 is distributed to passage 54 of core tip 30 as well.

Core tip 30 may be secured within socket 38 of core body 28 by a number of different means including, for example, welding or threaded interengagement between the two parts. However, in a preferred embodiment of the invention, core tip 30 is held in place by a shrink fit relationship between socket 38 and core tip 30. Thus, in one preferred embodiment, the inside diameter X of recess 40 is slightly smaller than the outside diameter Y of base portion 46 of core tip 30. By sufficiently heating socket 38, recess 40 will expand to such an extent that it can easily receive the base portion 46 of core tip 30. Then, by allowing socket 38 to cool back down to room temperature (on the order of 75° Fahrenheit), socket 38 shrinks so as to reduce the inside diameter X of recess 40 and cause base portion 46 to be tightly and securely gripped by sidewall 44.

It has been discovered that an excellent way of heating socket 38 to enlarge recess 40 for receiving core tip 30 is through an induction heating process. One suitable machine for carrying out the induction heating process is the PARLEC THERMOGRIP 3200 ISG machine available from Parlec, Inc. of Fairport, N.Y. A suitable induction heating machine of this type is also disclosed in U.S. Pat. No. 6,712,367 titled “Device for Clamping Tool”, said patent being hereby incorporated by reference into the present specification.

The Parlec machine has a vertically reciprocable induction coil which may be raised and lowered toward and away from a support bed. A core body 28 to be assembled is placed upon the bed in an upstanding or upright condition with bottom end 32 facing upwardly so that recess 40 opens upwardly. The coil is then lowered into surrounding relationship with the socket 38, whereupon the coil is acted upon by a high frequency alternating current. The field lines created by the induction coil penetrate into the socket 38 and cause a temperature elevation by production of an eddy current. After exposing the socket 38 to the induction coil for a short period of time (preferably less than thirty seconds), the recess 40 will have expanded enough to allow the coil to be raised and the core tip 30 inserted into socket 38 with base portion 46 received within recess 40. Subsequent cooling of socket 38 back down to room temperature causes core tip 30 to be tightly gripped within socket 38, preventing its accidental dislodgement therefrom.

By having core body 28 and core tip 30 comprise two separate components that are assembled together to make a complete core assembly 16, core tip 30 and core body 28 may be constructed from two different materials to best suit the situation at hand. The thermal conductivity of core body 28 may be higher or lower than that of core tip 30 as may be necessary or desirable. For example, in one preferred embodiment core body 28 may be fabricated from the highly wear resistant tool steel such as, for example, D-2, H-13, or S-7 tool steel. On the other hand, core tip 30 may be constructed from a more exotic material having a significantly different thermal conductivity than core body 28. Examples of such materials for core tip 30 may include aluminum alloys such as 7075 T-6, steel alloys such as L-6, and bronze alloys such as Ampco 940. In one preferred embodiment where the core body 28 is constructed from H-13 tool steel and the core tip 30 is constructed from a bronze alloy, the inside diameter X of recess 40 at room temperature is 0.7121 inches and the outside diameter Y of base portion 46 at room temperature is 0.7141 inches.

It will be appreciated that there are significant advantages in having the core constructed from two different parts and different materials. For example, a substantial cost savings can be realized where core tip 30 is constructed from an exotic, rather costly material but core body 28 is constructed from a much less costly material. Further, core body 28 may be constructed from a material that has significantly higher wear resistance than core tip 30, permitting core body 28 to be recycled and reused many times over after simply replacing a worn core tip 30. It will be appreciated in this respect that worn core tips can be removed from their core bodies by again subjecting socket 38 to high heat, preferably through the application of an induction coil thereto, the core tip being removed at such time as recess 40 expands sufficiently to allow such removal. While expanded, the next core tip can be readily installed in recess 40.

Utilizing the induction heating technic as above described provides a quick, clean and safe way of installing core tips within their core bodies. It also helps assure that the core tip is perfectly centered within its core body, which concentric relationship is critical to the production of high quality preforms having the proper wall thickness throughout.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. An injection core assembly for use in an injection molding machine, said core assembly comprising:
an elongated core body having a socket at one end provided with an axially extending recess; and
an elongated core tip having exterior molding surfaces thereon and projecting axially from said socket,
said tip having a base fixedly secured within said recess by shrink fit relationship with the socket,
wherein said socket has been induction heated to expand the recess sufficiently to receive the base of the tip and then cooled to room temperature to grip the tip against dislodgement.

2. An injection core assembly as claimed in claim 1, said tip being constructed from a different material than the socket.

3. An injection core assembly as claimed in claim 1,
said body being constructed from a first metallic material and the tip being constructed from a second metallic material.

4. An injection core assembly as claimed in claim 3,
said first metallic material having a lower thermal conductivity than the second metallic material.

5. An injection core assembly as claimed in claim 3,
said first metallic material having a higher thermal conductivity than the second metallic material.

6. An injection core assembly for use in an injection molding machine comprising:
an elongated core body constructed from a first metallic material; and
an elongated core tip having exterior molding surfaces thereon and projecting axially from one end of said body,
said tip being constructed from a second metallic material.

7. An injection core assembly as claimed in claim 6, said first and second materials having different thermal conductivities.

8. An injection core assembly as claimed in claim 7, said second material having a higher thermal conductivity than said first material.

9. An injection core assembly as claimed in claim 7, said second material having a lower thermal conductivity than said first material.

10. An injection core assembly as claimed in claim 6,
said body having a socket at said one end provided with an axially extending recess,
said tip having a base fixedly secured within said recess by shrink fit relationship with the socket,
wherein said socket has been induction heated to expand the recess sufficiently to receive the base of the tip and then cooled to room temperature to grip the tip against dislodgement.

11. A method of making an injection core assembly comprising:
providing an elongated core body having a socket at one end that has an axially extending recess;
providing an elongated core tip having exterior molding surfaces thereon,
said tip further having a base provided with an outside diameter that exceeds the inside diameter of said recess at room temperature;
subjecting said socket to induction heating until the inside diameter of said recess exceeds the outside diameter of said base of the tip;
inserting the base of the tip into said recess while the inside diameter of the recess exceeds the outside diameter of the base; and
cooling the socket to room temperature to produce a shrink fit relationship between the socket and the base of the tip to cause the socket to grip the tip against dislodgement.

12. A method as claimed in claim 11, said tip being constructed from a different material than the socket.

13. A method as claimed in claim 11,
said body being constructed from a first metallic material and the tip being constructed from a second metallic material.

14. A method as claimed in claim 13,
said first metallic material having a lower thermal conductivity than the second metallic material.

15. A method as claimed in claim 13,
said first metallic material having a higher thermal conductivity than the second metallic material.
